(19) United States
(12) Patent Application Publication
(10) Pub. No.: US 2018/0304592 A1
(43) Pub. Date: Oct. 25, 2018

(54) MOUNTING TAB, DISPENSER FOR SAME, AND METHOD OF USE

(71) Applicant: 3M INNOVATIVE PROPERTIES COMPANY, St. Paul, MN (US)

(72) Inventors: Douglas P. BODZIAK, Lake Elmo, MN (US); Jordan C. DUCHARME, Apple Valley, MN (US)

(21) Appl. No.: 15/751,749

(22) PCT Filed: Dec. 28, 2016
(86) PCT No.: PCT/US2016/068873

§ 371 Date: Feb. 9, 2018

Related U.S. Application Data
(60) Provisional application No. 62/272,395, filed on Dec. 29, 2015.

(51) Int. Cl. B32B 25/08; B32B 25/12; B32B 27/08; B65D 83/00; C09J 7/20

(52) U.S. Cl. CPC B32B 25/08; B32B 25/12; C09J 107/00; B65D 83/00; C09J 7/20; B32B 27/08

(57) ABSTRACT

Mounting tabs with dual adhesive sides that can be used to render articles adhesively capable for mounting on a support surface. Also, a dispenser for dispensing and using such mounting tabs, and a method of dispensing and using such tabs.

### FIELD

This invention relates to mounting tabs for rendering articles (e.g., posters, paper sheets, photographs, and the like) self-adherent such that they can be affixed to a substrate, and dispensers and methods for using such tabs.

### BACKGROUND

It is a common practice to temporarily hang items such as notes, children's artwork, photographs, etc. on any of a variety of surfaces (e.g., wall, window, door, mirror, refrigerator door, cupboard door, etc.). Some products, such as POST-IT® Notes and POST-IT® Easel Pads can be purchased already equipped to or adapted to, in addition being writable, be capable of temporarily mounting on a wall or other surface.

For years, strips of tape (e.g., office tape, masking tape, etc.) have been used to hang articles which are not inherently capable of mounting. In more polished applications, strips of one sided adhesive tape are wound into loops with the adhesive side facing out (sometimes referred to as a “teacher's loop”) and placed on the back of an article and then used to adhere or mount the article to a wall or other desired surface, typically with the loop substantially obscured out of sight behind the article.

In recent years, double-sided tapes and mounting products (e.g., SCOTCH® Indoor Mounting Tape and SCOTCH® Indoor Mounting Squares) for temporary and longer applications have become known on the market.

The need exists for more convenient, easier ways to render articles self-adherent such that they can be affixed to a substrate as desired.

### SUMMARY

The present invention provides novel mounting tabs that can be used to impart self-adherent capability to articles such that they can be affixed to a substrate as desired. The present invention also provides dispensers for attaching such mounting tabs to articles, and methods of use.

In brief summary, a mounting tab of the invention has a mounting face and an attachment face, and comprises a backing having opposing first and second major faces, mounting adhesive on the first major face, and attachment adhesive on the second major face. The second major face and attachment adhesive thereon are adapted to adhere sufficiently strongly to support the article as desired when the mounting tab is affixed to a substrate. If the intended application is to use the mounting tab to hang an article such as a photograph or poster on a wall, the bond provided by the attachment adhesive must be sufficient to support the weight of article. The first major face and mounting adhesive thereon are adapted to adhere sufficiently strongly to support the article and mounting tab on the substrate as desired. If the intended application is to use the mounting tab to hang an article on a wall, the bond provided by the mounting adhesive must be sufficient to support the weight of the article and the mounting tab.

Briefly summarizing, a dispenser of the invention comprises a handling member and a plurality of the mounting tabs of the invention arranged in a sequential stack.

In brief summary, a method of the invention for mounting an article on a support surface comprises:

providing an article;

providing a mounting tab as described herein;

contacting the second face of the mounting tab to the article and affixing the mounting tab to the article thereby yielding a composite article; and

contacting the first face of the mounting tab to a first location on the support surface and adhering the mounting tab to such first location such that the composite article is mounted on the support surface.

In its various aspects, the invention provides numerous and surprising advantages in convenience, ease of use, low cost, efficiency, and capability.

### BRIEF DESCRIPTION OF THE DRAWINGS

The invention is further explained with reference to the drawing wherein:

FIG. 1 is a cross sectional schematic of an illustrative embodiment of a mounting tab of the invention;

FIG. 2 is a cross sectional schematic of another illustrative embodiment of a mounting tab of the invention;

FIG. 3 is a cross sectional schematic of still another illustrative embodiment of a mounting tab of the invention;

FIG. 4 is a cross sectional schematic of an illustrative embodiment of a dispenser for attaching mounting tabs of the invention;

FIG. 5 is a cross sectional schematic of another illustrative embodiment of a dispenser for attaching mounting tabs of the invention;

FIG. 6 is a cross sectional schematic of attachment of a mounting tab to an article in accordance with the invention; and

FIG. 7 is a cross sectional schematic of an article mounted on a surface with a mounting tab in accordance with the invention.

These figures are not to scale and are intended to be merely illustrative and not limiting.

### Key and Glossary

For the following defined terms, these definitions shall be applied, unless a different definition is given in the claims or elsewhere in this specification.

The term “polymer” will be understood to include polymers, copolymers (e.g., polymers formed using two or more different monomers), oligomers and combinations thereof, as well as polymers, oligomers, or copolymers that can be formed in a miscible blend by, for example, coextrusion or reaction, including transesterification. Both block and random copolymers are included, unless indicated otherwise.

Unless otherwise indicated, all numbers expressing quantities of ingredients, properties such as molecular weight, reaction conditions, and so forth used in the specification and claims are to be understood as being modified in all instances by the term “about”. Accordingly, unless indicated to the contrary, the numerical parameters set forth in the foregoing specification and attached claims are approximations that can vary depending upon the desired properties sought to be obtained by those skilled in the art utilizing the teachings of the present invention. At the very least, and not as an attempt to limit the application of the doctrine of equivalents to the scope of the claims, each numerical parameter should at least be construed in light of the number of reported significant digits and by applying ordinary rounding techniques. Notwithstanding that the numerical ranges and parameters setting forth the broad scope of the invention are approximations, the numerical values set forth in the specific examples are reported as precisely as possible. Any numerical value, however, inherently contains certain errors necessarily resulting from the standard deviations found in their respective testing measurements.

The recitation of numerical ranges by endpoints includes all numbers subsumed within that range (e.g., 1 to 5 includes 1, 1.5, 2, 2.75, 3, 3.80, 4, and 5). As used in this specification and the appended claims, the singular forms “a”, “an”, and “the” include plural referents unless the content clearly dictates otherwise. Thus, for example, reference to a composition containing “a compound” includes a mixture of two or more compounds. As used in this specification and the appended claims, the term “or” is generally employed in its sense including “and/or” unless the content clearly dictates otherwise.

For purposes of clarity and without intending to be unduly limited thereby, the mounting tabs in a group of any three sequentially stacked mounting tabs are referenced as an overlying mounting tab, an intermediate mounting tab, and an underlying mounting tab with the mounting adhesive of the overlying mounting tab adhered to the second major face of the intermediate mounting tab, and the mounting adhesive of the intermediate mounting tab adhered to the adhered to the second major face of the underlying mounting tab and the attachment adhesive of the intermediate mounting tab adhered to first major face of the overlying mounting tab.

### DETAILED DESCRIPTION OF ILLUSTRATIVE EMBODIMENTS

FIG. 1 shows a cross sectional schematic of an illustrative embodiment of a mounting tab of the invention wherein tab 10 has mounting face 12 and attachment face 14. Tab 10 comprises backing 16 having opposing first and second major faces 18, 20, mounting adhesive 22 on first major face 18, and attachment adhesive 24 on second major face 20.

In this embodiment, the mounting adhesive and attachment adhesive, which are on opposing sides of the tab, are located at opposite ends of the tab.

FIG. 2 shows a cross sectional schematic of another illustrative embodiment of a mounting tab of the invention wherein tab 11 has mounting face 12 and attachment face 14. Tab 11 comprises backing 16 having opposing first and second major faces 18, 20, mounting adhesive 22 on first major face 18, and attachment adhesive 24 on second major face 20.

In this embodiment, attachment adhesive 24 is in two segments located at opposing ends of attachment face 14. In addition, corresponding segments 26, 28 of release coating are provided at opposing ends of mounting face 12 to facilitate separation of tab 11 from an underlying tab (not shown) in a stack of mounting tabs.

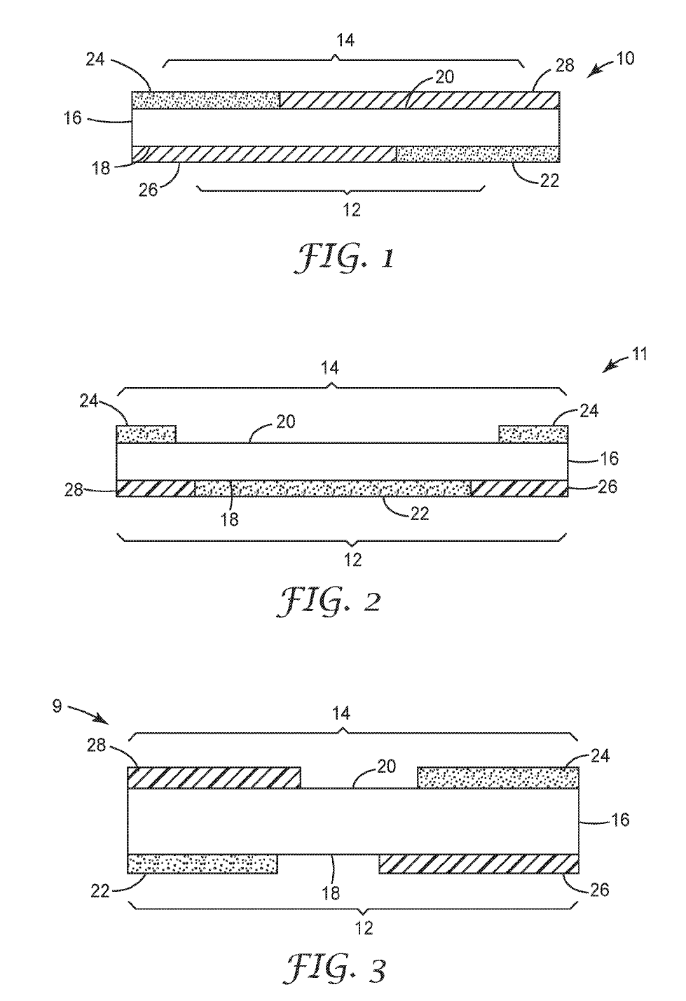

FIG. 3 shows a cross sectional schematic of another illustrative embodiment of a mounting tab of the invention wherein tab 9 has mounting face 12 and attachment face 14. Tab 9 comprises backing 16 having opposing first and second major faces 18, 20, mounting adhesive 22 on first major face 18, and attachment adhesive 24 on second major face 20. In addition, corresponding segments of release coating 26, 28 are provided on opposing sides of backing 16 to facilitate separation of tab 9 from an underlying tab (not shown) in a sequential stack of mounting tabs.

### Backing

Mounting tabs of the invention are typically generally flat with length and width dimensions defining the sizes of the respective first and second major faces and a front to back dimension (i.e., from the surface of the first major face to the surface of the second major face) or thickness.

As will be understood, mounting tabs of the invention can be made in any suitable size. In typical embodiments, the mounting tab will have a shortest dimension of at least about 0.5 inch (1.2 cm) and a longest dimension of about 6 inches (15.2 cm) or less. Illustrative examples include 1.75 by 1 inch (4.4 by 2.5 cm), 0.5 by 1 inch (1.2 by 2.5 cm), and 4 by 6 inches (10 by 15). In typical embodiments, the mounting tab will have a thickness or front to back dimension of from about 1.5 mil to about 4 mils (38 to 100 micrometers).

The backing should be sufficiently flexible to permit bending as necessary to permit it to be dispensed from a stack, capable of returning to a flat configuration after being bent to be dispensed, and sufficiently strong to withstand being pulled from the stack during dispensing and to support the article when in use.

Typically the backing comprises, and may even consist of, a sheet selected from the group consisting of paper or polymer. Illustrative examples of polymer films that can be used as backings include claim cellulose acetate, polypropylene (e.g., biaxially oriented), and polyester.

In many embodiments the backing is substantially rectangular (e.g., square or elongate) but backings of other shape may be used if desired (e.g., circular, oval, star-shaped, etc.).

### Mounting Adhesive

The mounting adhesive is used to support the combined mounting tab and article (referred to herein as a composite article) to a desired support surface.

In many embodiments, the mounting adhesive is a pressure sensitive adhesive. Typically, pressure sensitive adhesives comprise one or more elastomers compounded with one or more tackifiers.

Illustrative examples of elastomers used in pressure sensitive adhesives include acrylics, butyl rubbers, ethylene-vinyl acetates, natural rubbers, nitriles, silicone rubber, styrene block copolymers, and vinyl ethers.

In many preferred embodiments, the mounting adhesive is a repositionable adhesive. That is, the adhesive will adhere reasonably well to a desired support surface (e.g., a wall, door, partition, furniture cabinet or panel, easel board, glass surface, shelving, refrigerator door, notebook page, book cover, and the like), typically at conventional ambient temperatures, and then remove cleanly (i.e., with minimal or no residue and without damage to the support surface), prior to possible attachment at a different location.

The selection of mounting adhesive (including, e.g., the strength of adhesive bonds which it provides to the substrate and to the backing, thickness, proportion or area of first major surface on which mounting adhesive resides) will be dependent in part upon the nature of the articles which the mounting tab might be used (e.g., weight, dimension), the nature of the support surfaces to it might be mounted, ambient conditions of use, the strength of the adhesive bond between the attachment adhesive and the article, etc. Those skilled in the art will be able to readily select suitable mounting adhesives for use in accordance with the invention. In some embodiments, the mounting adhesive is an acrylate based microsphere adhesive.

### Attachment Adhesive

The attachment adhesive is selected to provide sufficiently strong bond between the mounting tab and the article to support the article. This may be a repositionable or permanent adhesive as desired. Typically it is desired that the attachment adhesive provide bonds to the backing and to the article that are stronger than the strength of the bond between the mounting adhesive and the wall.

In many embodiments the attachment adhesive is a pressure sensitive adhesive. Typically, pressure sensitive adhesives comprise one or more elastomers compounded with one or more tackifiers.

Illustrative examples of elastomers used in pressure sensitive adhesives include acrylics, butyl rubbers, ethylene-vinyl acetates, natural rubbers, nitriles, silicone rubber, styrene block copolymers, and vinyl ethers.

The attachment adhesive may be a permanent adhesive (i.e., one which will adhere substantially inseparably to the article) or a repositionable adhesive (i.e., one which may be separated from the article for subsequent attachment to another location on the article or to a different article, or to leave the article in intact form).

The selection of attachment adhesive (including, e.g., the strength of adhesive bonds which it provides to the article and to the backing, thickness, proportion or area of second major surface on which attachment adhesive resides) will be dependent in part upon the nature of the articles which the mounting tab might be used (e.g., weight, dimension, surface characteristics), ambient conditions of use, nature of mounting adhesive, etc. Those skilled in the art will be able to readily select suitable attachment adhesives for use in accordance with the invention. In some embodiments, the mounting adhesive is an acrylate based microsphere adhesive.

Typically it is preferred that the attachment adhesive bond more strongly to the article than the mounting adhesive does to the support surface. Preferably, the mounting adhesive will adhere more strongly to the backing of the mounting tab than it does to the support surface. Preferably the attachment adhesive will bond more strongly to the backing of the mounting tab than does the mounting adhesive to the support surface.

### Dispenser

In a preferable manner of use, mounting tabs of the invention are arranged in a sequential stack comprising a plurality of tabs such that the second major faces of adjacent mounting tabs are oriented in the same direction. In this manner, the mounting tabs in a group of any three sequentially stacked mounting tabs are referenced as an overlying mounting tab, an intermediate mounting tab, and an underlying mounting tab with the mounting adhesive of the overlying mounting tab adhered to the second major face of the intermediate mounting tab, and the mounting adhesive of the intermediate mounting tab adhered to the adhered to the second major face of the underlying mounting tab and the attachment adhesive of the intermediate mounting tab adhered to first major face of the overlying mounting tab.

In some embodiments, the mounting tabs in the stack are arranged in an alternating Z-stack (such as is done with repositionable tape flags), in other embodiments they are oriented uniformly.

Typically it is preferable to use the stack with a dispenser to facilitate handling and storage of the tabs as well as application of the tabs to articles as desired.

In preferred embodiments, mounting tabs may be dispensed and applied to articles in pop up fashion from a dispenser in accordance with the invention. Advantages include easy handling and application of tabs to articles as desired without fouling (e.g., as frequently happens when handling individual tape strips, particularly two-sided tape) and easy placement of the mounting tab in desired location on the article.

As will be understood, dispensers may take many forms. Typically, the dispenser comprises at least a handling member adapted for grasping and handling the dispenser and stack of mounting tabs contained therein as desired. In some embodiments, the dispenser comprises a body portion adapted for grasping or handling the dispenser and contained stack of tabs as desired and further comprises a dispensing wall through which tabs may be extracted singly as they are attached to articles as desired, thereby facilitating separation of individual mounting tabs from the stack.

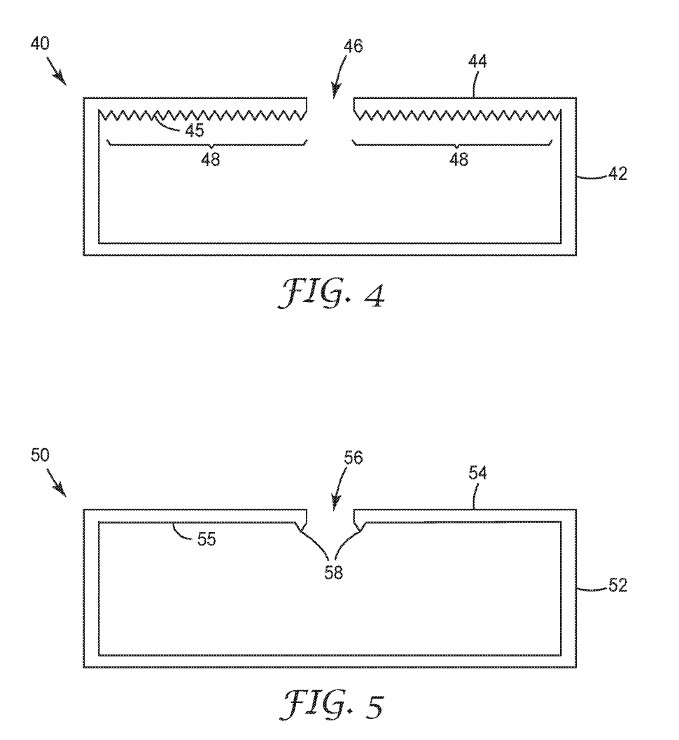

FIG. 4 snows an illustrative dispenser 40 comprising body 42 and dispensing wall 44 with opening 46. FIG. 5 shows an illustrative dispenser 50 comprising body 52 and dispensing wall 54 with opening 56.

In typical use, the sequential stack of tabs is arranged such that the second major faces of the mounting tabs (with attachment adhesive thereon) are oriented toward the dispensing wall.

In some embodiments, the interior portion of the dispensing wall is adapted to limit adhesion of the attachment adhesive to the dispensing wall.

One illustrative example of adaptation which may be used include roughened surface, of either the entirety of the interior surface of the dispensing wall or at least that portion adjacent the opening where contact with the attachment adhesive is most prominent. FIG. 4 shows an illustrative embodiment where a portion of the interior surface 45 of dispensing wall 44 has roughened surface 48. The roughened surface may be provided by embossing or forming features in the dispensing wall (e.g., an array of bumps, dots, or other protrusions or texture) or placement of a suitably faced material (e.g., non-woven fabric, hook and loop material, etc.)

Another illustrative example of adaptation is ridgelines, points, or other surface features configured to minimize the contact of the attachment adhesive to the dispensing wall. FIG. 5 shows an illustrative embodiment where interior surface 55 has ridges 58 adjacent opening 56.

Other adaptations may be used, instead or in combination with one or both of these embodiments (e.g., such as low adhesion coatings).

### Use

Mounting tabs of the invention may be used to secure articles to support surfaces as desired. Illustrative examples include desk tops, table tops, note books, file folders, documents, book pages and covers, etc. Illustrative examples of generally upright support surfaces on which mounting tabs of the invention may be used include walls, partitions, furniture cabinets and panels, easel boards, doors, windows, shelving, and the like.

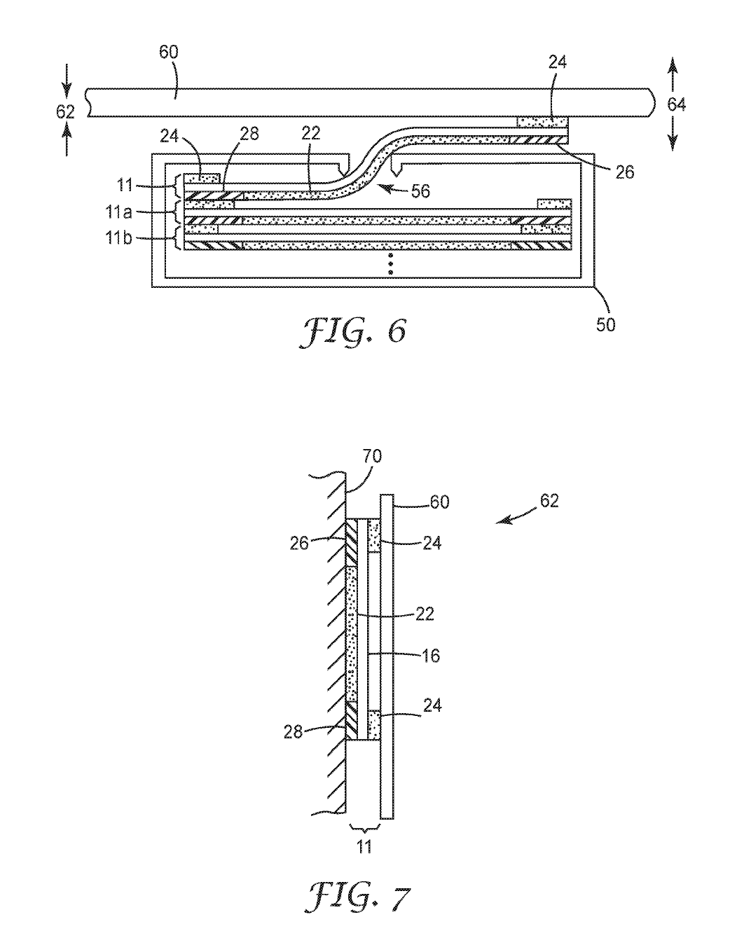

FIG. 6 shows an illustrative embodiment of the method of the invention wherein dispenser 50 containing a stack of mounting tabs of the invention. The uppermost tab 11a is shown, extending partially through opening 56 (the remainder of the stack, comprising a plurality of similar mounting tabs 11b et seq. is located within the dispenser). To use the invention an article such as a sheet of paper 60 (or photograph, note card, etc.) is provided and contacted to attachment adhesive 24 (e.g., by moving in relative vector 62). This can be achieved by manipulating paper 60 contact with the protruding portion of mounting tab 11a and attachment adhesive 24 thereon, at the desired position on paper 60 so as to achieve a bond (e.g., by pressure, such as finger pressure with preferred pressure sensitive adhesives) between the attachment adhesive and the paper; or manipulating the dispenser with protruding mounting tab such that attachment adhesive 24 contacts the surface of paper sheet 60, at the desired position on paper 60 so as to achieve a bond (e.g., by pressure, such as finger pressure with preferred pressure sensitive adhesives) between the attachment adhesive and the paper; or some combination of both.

After the initial bond between mounting tab 11 and article 60 is achieved, the article and dispenser are separated (e.g., moved in relative vector 64). As the distance of separation grows, the remainder of mounting tab 11a is pulled from the stack and through opening 56. The overlying first mounting tab 11b is ultimately pulled completely through opening 56, serving as a leader to pull a leading edge of the underlying mounting tab through the opening, and then separating therefrom.

In the embodiment shown, mounting tab 11a has another segment of attachment adhesive 24 which contacts and adheres to sheet 60.

Thereafter, the sheet with the mounting tab attached thereto, referred to as a composite article may be mounted on a support surface. An illustrative embodiment is shown in FIG. 7, where composite article 62 comprising sheet 60 and mounting tab 11 is mounted on surface 70 held by mounting adhesive 22.

In alternative embodiments, the mounting tab may first be mounted on a support surface (via the mounting adhesive) and then an article such as a sheet attached to the mounting tab (via the attachment adhesive) so as to affix the article to the support surface.

Although the present invention has been fully described in connection with the preferred embodiments thereof with reference to the accompanying drawings, it is to be noted that various changes and modifications are apparent to those skilled in the art. Such changes and modifications are to be understood as included within the scope of the present invention as defined by the appended claims unless they depart therefrom.

The complete disclosure of all patents, patent documents, and publications cited herein are incorporated by reference. The foregoing detailed description and examples have been given for clarity of understanding only. No unnecessary limitations are to be understood therefrom. The invention is not limited to the exact details shown and described, for variations obvious to one skilled in the art will be included within the invention defined by the claims.

What is claimed is:

1. A mounting tab having a mounting face and an attachment face, the mounting tab comprising:
a backing having opposing first and second major faces;
a mounting adhesive on the first major face of the backing, wherein the mounting adhesive is a microsphere-based adhesive; and
an attachment adhesive on the second major face of the backing.

2. The mounting tab of claim 1 wherein the mounting adhesive is a pressure sensitive adhesive.

3. The mounting tab of claim 1 wherein the mounting adhesive comprises one or more elastomers compounded with tackifier.

4. The mounting tab of claim 3 wherein the elastomer is selected from the group consisting of acrylics, butyl rubbers, ethylene-vinyl acetates, natural rubbers, nitriles, silicone rubber, styrene block copolymers, and vinyl ethers.

5. The mounting tab of claim 1 wherein the mounting adhesive is an acrylate based microsphere adhesive.

6. The mounting tab of claim 1 wherein the attachment adhesive comprises one or more elastomers compounded with tackifier.

7. The mounting tab of claim 6 wherein the elastomer is selected from the group consisting of acrylics, butyl rubbers, ethylene-vinyl acetates, natural rubbers, nitriles, silicone rubber, styrene block copolymers, and vinyl ethers.

8. The mounting tab of claim 1 further comprising:
a release agent on the second major face of the backing.

9. The mounting tab of claim 1 wherein backing has a shortest dimension of at least about 0.5 inch (1.2 cm) and a longest dimension of about 6 inches (15 cm) or less.

10. The mounting tab of claim 1 wherein the backing comprises a sheet selected from the group consisting of paper or polymer.

11. The mounting tab of claim 1 wherein the backing comprises polymer film selected from the group consisting of cellulose acetate, polypropylene, or polyester.

12. The mounting tab of claim 1 wherein the backing is substantially rectangular in shape.

13. A stack comprising a plurality of the mounting tabs of claim 1 arranged in a sequential stack such that the second major faces of adjacent mounting tabs are oriented in the same direction.

14. The stack of claim 13 wherein the mounting tabs are arranged in an alternating Z-stack.

15. A dispenser comprising a handling member and a plurality of the mounting tabs of claim 1 arranged in a sequential stack such that the second major faces of adjacent mounting tabs are oriented in the same direction.

16. The dispenser of claim 15 comprising a dispensing wall having an opening through which mounting tabs may be single dispensed, wherein the stack is arranged such that the second major faces of mounting tabs are oriented toward the dispensing wall.

17. The dispenser of claim 16 wherein the interior portion of the dispensing wall is adapted to limit adhesion of the attachment adhesive of the mounting tabs thereto.

18. A method for mounting an article on a support surface comprising:
providing an article;
providing a mounting tab of claim 1;
contacting the second face of the mounting tab to the article and adhering the mounting tab to the article thereby yielding a composite article; and
contacting the first face of the mounting tab to a first location on the support surface and adhering the mounting tab to such first location such that the composite article is mounted on the support surface.

19. The method of claim 18 wherein the mounting tab is in a sequential stack of a plurality of similar mounting tabs and wherein the mounting tab separates from the stack after the mounting tab adheres to the article.

20. The method of claim 18 further comprising removing the composite article from the first location and then contacting the first face of the mounting tab to another support location on the same or different support surface.
